(19) United States
(12) Patent Application Publication
(10) Pub. No.: US 2025/0350207 A1
(43) Pub. Date: Nov. 13, 2025

(54) CONTROL SYSTEM FOR MULTI-PHASE CONTROL OF HIGH VOLTAGE CONVERTER AND THE METHOD THEREFOR

(71) Applicant: HL Mando Corporation, Gyeonggi-do (KR)

(72) Inventors: Suwan WOO, Gyeonggi-do (KR); Jiho MOON, Gyeonggi-do (KR)

(21) Appl. No.: 18/827,417

(22) Filed: Sep. 6, 2024

(30) Foreign Application Priority Data
May 8, 2024 (KR) 10-2024-0060335

(51) Int. Cl. H02M 3/158; H02M 1/14; H02M 3/157

(52) U.S. Cl. CPC H02M 3/1584; H02M 1/14; H02M 3/157

(57) ABSTRACT

A control system for multi-phase control of a high-voltage converter includes: a multi-phase converter including inputs and outputs each connected in parallel to convert a direct current (DC) input voltage into a DC output voltage of a different level, and having different phases; and a microcontroller outputting a control signal, which is a PWM signal, to boost or lower the DC input voltage of the multi-phase converter to the DC output voltage of a different level, wherein the microcontroller includes at least one core, and the core includes: a first controller controlling two phases of the multi-phase converter having a phase difference of 180 degrees; and a second controller controlling two different phases of the multi-phase converter having a phase difference of 180 degrees and having a predetermined phase difference from the two phases of the first controller.

### CROSS-REFERENCE TO RELATED APPLICATION

This application claims priority under 35 U.S.C. § 119 to Korean Patent Application No. 10-2024-0060335, filed on May 8, 2024, in the Korean Intellectual Property Office (KIPO), the disclosure of which is incorporated by reference herein in its entirety.

### TECHNICAL FIELD

The present disclosure relates to a control system for multi-phase control of a high-voltage converter and a method therefor, and more particularly, to a control system for multi-phase control of a voltage converter capable of effectively distributing the increasing number of phases of multi-phase control to further increase the number of phases for which multi-phase control is possible in order to reduce voltage ripple of the high-voltage converter, and a method therefor.

### DISCUSSION OF RELATED ART

Recently, DC-DC converters are being applied to various power conversion devices such as automobile battery chargers. When a voltage is increased using a DC-DC converter, current ripple occurs in an inductor within the converter. This current ripple affects the size of elements such as inductors and capacitors and is closely related to the amount of power loss.

In accordance with the demand for size reduction of passive elements, a method of reducing switch ripple by increasing the number of phases is being applied. In addition, fast PWM frequency and synchronous control are required.

A multi-phase converter is a converter that distributes the flow of current by connecting multiple DC-DC converters in parallel, and may reduce the size and ripple of the current applied to elements such as inductors by utilizing a phase difference of switching elements.

The multi-phase converter may reduce the current ripple of input and output by distributing the flow of current while providing an appropriate phase difference to the current. In addition, by using such a multi-phase converter, energy efficiency may be increased, and the size and weight of elements within the circuit may be reduced.

However, as the number of phases increases, due to the resource limitations of a microcontroller (MCU), the number of phases that may be multiple-phase controlled is limited and the reduction effect in passive component capacity and size is minimal.

FIG. 1 is a diagram illustrating an output signal of a multi-phase PWM control method according to a prior art. As illustrated in FIG. 1, a controller is operated immediately after AD sampling at a center point of a PWM duty of phase A, phase B, phase C, and phase D. Here, a PWM output signal of each phase is performed by each controller.

However, as a phase difference of the phases decreases, and as multiple controllers are operated, an executable time of each controller decreases. This may delay a start point of the control operation, and in this case, it may be difficult to secure a control cycle, making it impossible to secure control performance. In addition, a resource occupancy of the microcontroller (MCU) also increases.

That is, as the number of phases increases, phase B is operated after phase A is operated (phase C is operated after phase B is operated, etc.), so a delay occurs in the control start point. In other words, the operation start point is not fixed, and it is difficult to secure the control cycle due to the delay, which causes a problem in that a feedback control is difficult.

### SUMMARY

The present disclosure is directed to providing a control system for multi-phase control of a voltage converter capable of effectively distributing the increasing number of phases of multi-phase control to further increase the number of phases for which multi-phase control is possible in order to reduce voltage ripple of the high-voltage converter, and a method therefor.

However, the technical objective to be achieved by embodiments of the present disclosure is not limited to the technical objective described above, and other technical objectives may exist.

According to an embodiment of the present disclosure, a control system for multi-phase control of a high-voltage converter includes: a multi-phase converter including inputs and outputs each connected in parallel to convert a direct current (DC) input voltage into a DC output voltage of a different level, and having different phases; and a microcontroller outputting a control signal, which is a PWM signal, to boost or lower the DC input voltage of the multi-phase converter to the DC output voltage of a different level, wherein the microcontroller includes at least one core, and the core includes: a first controller controlling two phases of the multi-phase converter having a phase difference of 180 degrees; and a second controller controlling two different phases of the multi-phase converter having a phase difference of 180 degrees and having a predetermined phase difference from the two phases of the first controller.

In some embodiments, when the core of the microcontroller is a single core and the first controller and the second controller control four phases, a first phase of the first controller may have a phase difference of 90 degrees from a first phase of the second controller, and a second phase of the first controller may have a phase difference of 90 degrees from a second phase of the second controller.

In some embodiments, the first controller and the second controller may perform AD sampling and analog-to-digital conversion for each phase at a center point of a PWM duty, and perform AD sampling and analog-to-digital conversion of the second controller at a point in time when each AD sampling and analog-to-digital conversion of the first controller is completed.

In some embodiments, when the microcontroller includes three cores, and the three cores control 12 phases, each core including a first controller and a second controller each controlling 2 phases, each phase of the first core may be controlled to sequentially have a phase difference of 30 degrees from each phase of the second core, and each phase of the second core may be controlled to sequentially have a phase difference of 30 degrees from each phase of the third core.

In some embodiments, the first controller and the second controller of each core may control two phases having a phase difference of 180 degrees, the first controller and the second controller of each core may perform AD sampling and analog-to-digital conversion for each phase at a center point of a PWM duty, and AD sampling and analog-to-digital conversion of the second controller may be performed at a point in time when each AD sampling and analog-to-digital conversion of the first controller is completed.

In some embodiments, when the microcontroller includes three cores, and the three cores control 18 phases, each core including a first controller, a second controller and a third controller each controlling 2 phases, each phase of the first core may be controlled to sequentially have a phase difference of 20 degrees from each phase of the second core, and each phase of the second core may be controlled to sequentially have a phase difference of 20 degrees from each phase of the third core.

In some embodiments, the first controller, the second controller and the third controller of each core may control two phases having a phase difference of 180 degrees, the first controller, the second controller and the third controller of each core may perform AD sampling and analog-to-digital conversion for each phase at a center point of a PWM duty, AD sampling and analog-to-digital conversion of the second controller may be performed at a point in time when each AD sampling and analog-to-digital conversion of the first controller is completed, and AD sampling and analog-to-digital conversion of the third controller may be performed at a point in time when each AD sampling and analog-to-digital conversion of the second controller is completed.

According to another embodiment of the present disclosure, a control method for multi-phase control of a high-voltage converter includes: outputting, from a microcontroller to a multi-phase converter including inputs and outputs each connected in parallel to convert a direct current (DC) input voltage into a DC output voltage of a different level, and having different phases, a control signal to boost or lower the DC input voltage of the multi-phase converter to the DC output voltage of a different level, the control signal being a PWM signal, wherein in a core of the microcontroller, a first controller controls two phases of the multi-phase converter having a phase difference of 180 degrees, and a second controller controls two different phases of the multi-phase converter having a phase difference of 180 degrees and having a predetermined phase difference from the two phases of the first controller.

In some embodiments, when the core of the microcontroller is a single core and the first controller and the second controller control four phases, a first phase of the first controller may have a phase difference of 90 degrees from a first phase of the second controller, and a second phase of the first controller may have a phase difference of 90 degrees from a second phase of the second controller.

In some embodiments, the first controller and the second controller may perform AD sampling and analog-to-digital conversion for each phase at a center point of a PWM duty, and perform AD sampling and analog-to-digital conversion of the second controller at a point in time when each AD sampling and analog-to-digital conversion of the first controller is completed.

In some embodiments, when the microcontroller includes three cores, and the three cores control 12 phases, each core including a first controller and a second controller each controlling 2 phases, each phase of the first core may be controlled to sequentially have a phase difference of 30 degrees from each phase of the second core, and each phase of the second core may be controlled to sequentially have a phase difference of 30 degrees from each phase of the third core.

In some embodiments, the first controller and the second controller of each core may control two phases having a phase difference of 180 degrees, the first controller and the second controller of each core may perform AD sampling and analog-to-digital conversion for each phase at a center point of a PWM duty, and AD sampling and analog-to-digital conversion of the second controller may be performed at a point in time when each AD sampling and analog-to-digital conversion of the first controller is completed.

In some embodiments, the second controller of a first core may perform AD sampling for a phase at a center point of a PWM duty at a point in time when AD sampling conversion of the first controller of a third core is completed, the second controller of a second core may perform AD sampling at a point in time when AD sampling conversion of the second controller of the first core is completed, and the second controller of the third core may perform AD sampling at a point in time when AD sampling conversion of the second controller of the second core is completed.

In some embodiments, when the microcontroller includes three cores, and the three cores control 18 phases, each core including a first controller, a second controller and a third controller each controlling 2 phases, each phase of the first core may be controlled to sequentially have a phase difference of 20 degrees from each phase of the second core, and each phase of the second core may be controlled to sequentially have a phase difference of 20 degrees from each phase of the third core.

In some embodiments, the first controller, the second controller and the third controller of each core may control two phases having a phase difference of 180 degrees, the first controller, the second controller and the third controller of each core may perform AD sampling and analog-to-digital conversion for each phase at a center point of a PWM duty, AD sampling and analog-to-digital conversion of the second controller may be performed at a point in time when each AD sampling and analog-to-digital conversion of the first controller is completed, and AD sampling and analog-to-digital conversion of the third controller may be performed at a point in time when each AD sampling and analog-to-digital conversion of the second controller is completed.

### BRIEF DESCRIPTION OF THE DRAWINGS

A more complete appreciation of the present disclosure will become more apparent by describing in detail exemplary embodiments thereof with reference to the accompanying drawings, wherein:

FIG. 1 is a diagram illustrating an output signal of a multi-phase PWM control method according to a prior art.

FIG. 2 is a diagram schematically illustrating a configuration of a control system for multi-phase control of a high-voltage converter according to an embodiment of the present disclosure.

FIG. 3 is a diagram illustrating an example of a configuration of a controller of a microcontroller of FIG. 2.

FIG. 4 is a diagram illustrating an output signal of a multi-phase PWM control method of FIG. 3.

FIG. 5 is a diagram illustrating another example of the configuration of the controller of the microcontroller of FIG. 2.

FIG. 6 is a diagram illustrating an output signal of a multi-phase PWM control method of FIG. 5.

FIG. 7 is a diagram illustrating yet another example of the configuration of the controller of the microcontroller of FIG. 2.

FIG. 8 is a diagram illustrating an output signal of a multi-phase PWM control method of FIG. 7.

FIG. 9 is a graph illustrating the relationship of a typical voltage ripple against the number of phases.

FIG. 10 is a graph illustrating the relationship of an inductor capacity against the number of phases based on a typical same voltage ripple.

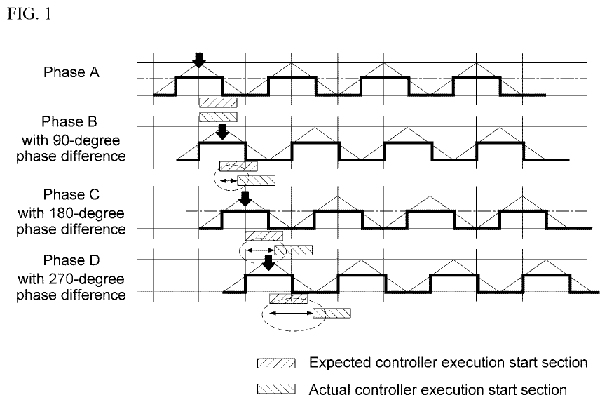

### DETAILED DESCRIPTION

Hereinafter, with reference to the accompanying drawings, embodiments of the present disclosure will be described in detail so that those skilled in the art may easily practice the disclosure. However, the present disclosure may be implemented in various different forms and is not limited to the embodiments described herein. In order to clearly describe the present disclosure, parts that are not related to the description in the drawings have been omitted, and similar portions have been given similar drawing references throughout the specification. In addition, in describing with reference to the drawings, even if the components are represented by the same name, the drawing references may be different depending on the drawings, and the drawing references are represented only for the convenience of description, and the concepts, features, functions, or effects of each component are not limited by the corresponding drawing references.

Throughout the specification, when a part is said to be “connected” to another part, this includes not only cases where it is “directly connected”, but also cases where it is “electrically connected” with another element in between. In addition, when a part is said to “include” a component, this does not mean excluding other components unless otherwise specifically stated, but rather that other components may be included, and it should be understood that it does not preclude the existence or possibility of addition of one or more other features, numbers, steps, operations, components, parts, or combinations thereof.

In this specification, a “part” or “module” may include a unit realized by hardware or software, a unit realized using both, and one unit may be realized using two or more pieces of hardware, and two or more units may be realized by one piece of hardware.

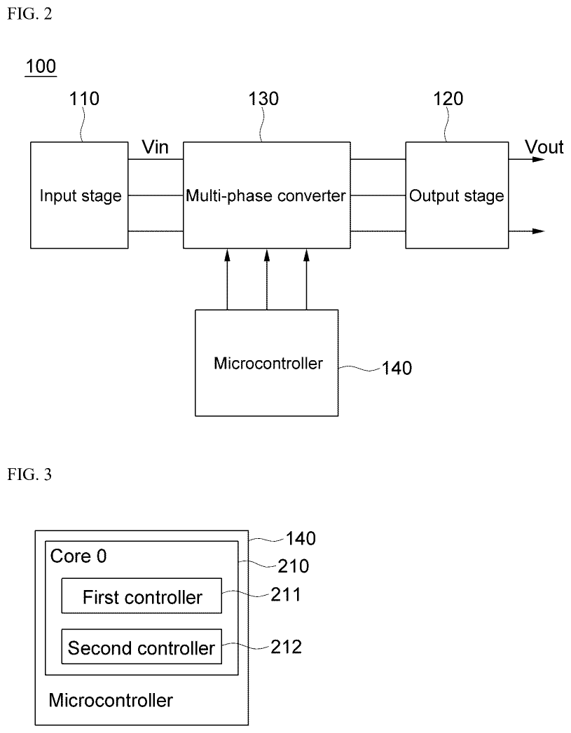

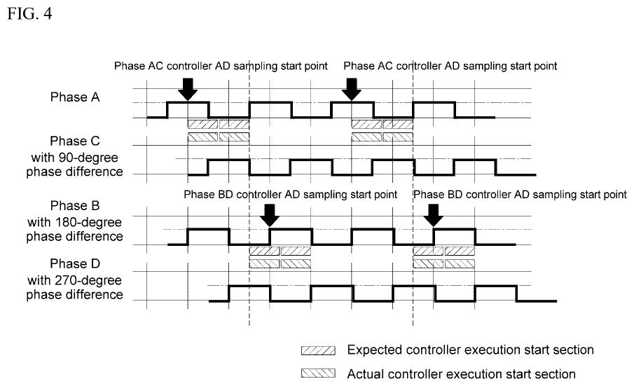

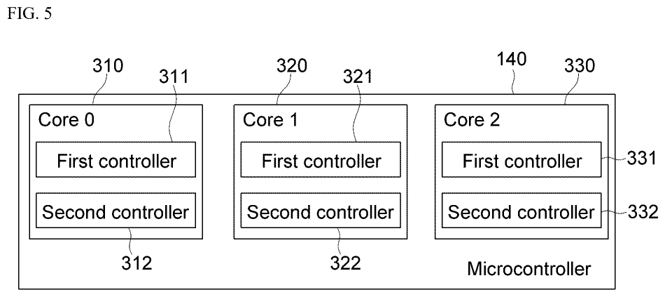

FIG. 2 is a diagram schematically illustrating a configuration of a control system for multi-phase control of a high-voltage converter according to an embodiment of the present disclosure, FIG. 3 is a diagram illustrating an example of a configuration of a controller of a microcontroller of FIG. 2, and FIG. 4 is a diagram illustrating an output signal of a multi-phase PWM control method of FIG. 3.

As illustrated in FIG. 2, a control system 100 for multi-phase control of a high-voltage converter according to an embodiment of the present disclosure may be configured to include an input stage 110, an output stage 120, a multi-phase converter 130, and a microcontroller 140.

The input stage 110 may be a fuel cell stack, which may be applied to a fuel cell electric vehicle (FCEV) and may become a main source of power (a main power source) of a vehicle driven by an electric motor such as an electric vehicle (EV). Here, the input stage 110, which is a fuel cell stack, may generate electricity (energy) by an electrochemical reaction of hydrogen and oxygen in the air. Although omitted in the drawing, the input stage 110 may include balance of plant (BOP), such as an air supply, a hydrogen supply, and a cooling pump, required for driving the generation of electricity.

The output stage 120 may be a high-voltage battery used as an auxiliary power source (auxiliary power) of the vehicle, charge the electricity generated by the input stage 110 and supply the charged electricity to drive a motor (not illustrated).

Accordingly, two high-voltage power sources, that is, the input stage 110 which is a fuel cell stack and the output stage 120 which is a high-voltage battery are mounted on the fuel cell vehicle and connected in parallel to a load side within the vehicle.

The multi-phase converter 130 may include inputs and outputs each connected in parallel to convert a DC input voltage into a DC output voltage of a different level, and may have different phases.

More specifically, the multi-phase converter 130 may be a bidirectional converter that is connected between the input stage 110 and the output stage 120 and matches a balance of the different output voltages of the output stage 120 and the input stage 110.

The multi-phase converter 130 boosts the voltage discharged from the output stage 120 and outputs it to a high-voltage bus terminal, thereby supplying a driving power to the motor (not illustrated). In addition, the multi-phase converter 130 may supply a start power to the input stage 110, which is an initial fuel cell stack.

The multi-phase converter 130 may charge the output stage 120, which is the high-voltage battery, with a power generated by a regenerative driving of the motor. In addition, the multi-phase converter 130 may operate in a boost mode or a buck mode by a control command of the controller according to an inductor that boosts the voltage and a motor operation state, and include a plurality of power switching elements (e.g., IGBT (Insulated Gate Bipolar Transistor)) (not illustrated) for operation in each mode.

The microcontroller 140 may output a control signal, which is a PWM signal, to boost or lower the DC input voltage of the multi-phase converter 130 to a DC output voltage of a different level.

More specifically, as illustrated in FIG. 3, the microcontroller 140 may include a single core (core 0, 210), and the core (core 0, 210) may include a first controller and a second controller.

Here, the first controller 211 may control two phases of the multi-phase converter 130 having a phase difference of 180 degrees, and the second controller 212 may control two different phases having a phase difference of 180 degrees, where the two different phases have a predetermined phase difference with each of the two phases of the first controller 211, respectively.

As illustrated in FIG. 4, the first controller 211 and the second controller 212 of the microcontroller 140 which is composed of a single core (core 0, 210) may control four phases.

A first phase of the first controller 211 is controlled to have a phase difference of 90 degrees from a first phase of the second controller 212.

A second phase of the first controller 211 is controlled to have a phase difference of 90 degrees from a second phase of the second controller 212.

In other words, the first controller 211 and the second controller 212 has a phase difference between each phase of 90 degrees, thus controlling 4 phases. Here, the first controller 211 and the second controller 212 perform AD sampling for each phase at a center point of a PWM duty, respectively. First, AD sampling of the second controller 212 is performed at a point in time when a conversion of each AD sampling of the first controller 211 is completed. For example, AD sampling is performed at a center point of a PWM duty of a phase A in the first controller 211, and a PWM signal of a phase C having a phase difference of 180 from the phase A is output.

Then, AD sampling is performed at a center point of a PWM duty of a phase B of the second controller at a point in time when a conversion of the AD sampling of the phase C is completed, and a PWM signal of a phase D having a phase difference of 180 from the phase B is output.

Accordingly, the controllable time may be secured for each controller, and an expected controller execution start section and an actual controller execution start section are matched, thereby eliminating the time delay element, and thus securing the control cycle.

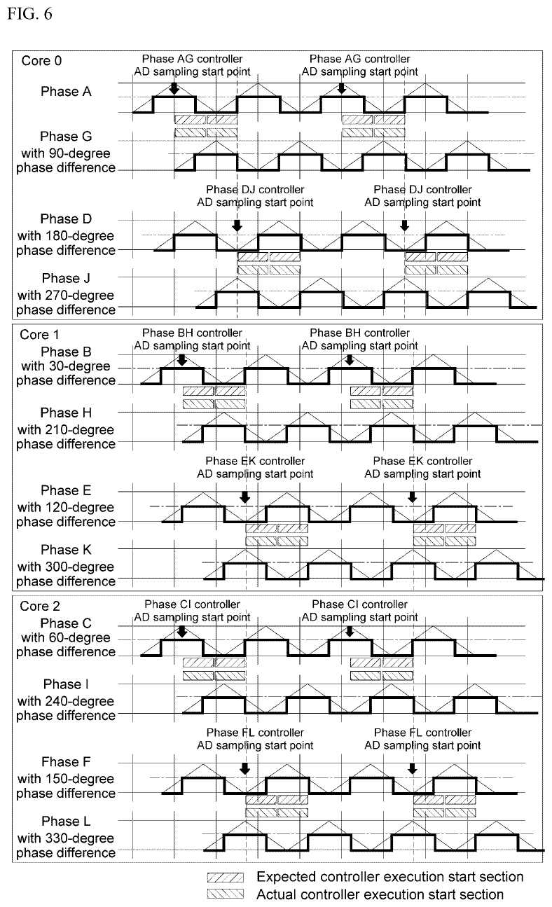

FIG. 5 is a diagram illustrating another example of the configuration of the controller of the microcontroller of FIG. 2, and FIG. 6 is a diagram illustrating an output signal of a multi-phase PWM control method of FIG. 5.

As illustrated in FIG. 5, the microcontroller 140 may include three cores 310, 320, 330

(core 0, core 1, core 2), and each core may include a first controller 311, 321, 331 and a second controller 312, 322, 332. Here, each controller may output two-phase PWM signals, and accordingly, a total of 12 phases may be controlled.

More specifically, as illustrated in FIG. 6, each phase of the first core 310 (core 0) may be controlled to sequentially have a phase difference of 30 degrees from each phase of the second core 320 (core 1), and each phase of the second core 320 (core 1) may be controlled to sequentially have a phase difference of 30 degrees from each phase of the third core 330 (core 2). Here, each core may independently control the phases of each controller.

For example, the first controller 311 of the first core 310 (core 0) may perform AD sampling and analog-to-digital conversion for a phase A and a phase G at a center point of a PWM duty.

Then, at a point in time when the AD sampling and analog-to-digital conversion for the phase A and the phase G of the first controller 311 of the first core 310 (core 0) are completed, AD sampling and analog-to-digital conversion for a phase D and a phase J of the second controller 312 of the first core 310 (core 0) are performed. Here, after the second controller 312 is operated, the first controller 311 and the second controller 312 are operated repeatedly in response to the PWM control signal.

In addition, AD sampling and analog-to-digital conversion of a phase B and a phase H of the first controller 321 of the second core 320 (core 1) are performed.

Then, at a point in time when the AD sampling and analog-to-digital conversion of the phase B and the phase H of the first controller 321 of the second core 320 (core 1) are completed, AD sampling and analog-to-digital conversion of a phase E and a phase K of the second controller 322 of the second core 320 (core 1) are performed.

In addition, AD sampling and analog-to-digital conversion of a phase C and a phase I of the first controller 331 of the third core 330 (core 2) are performed. Then, when the AD sampling and analog-to-digital conversion for the phase C and the phase I of the first controller 331 of the third core 330 (core 2) are completed, AD sampling and analog-to-digital conversion for a phase F and a phase L of the second controller 332 of the third core 330 (core 2) are performed.

In such a case, in order to secure a control execution time of each core, the control is performed once every two PWM cycles, such that the second controller is performed after completion of the first controller of each core.

Accordingly, in each core, two phases with a phase difference of 180 degrees may be assigned, and the PWM signal may be controlled by the two controllers, such that the controllable time for each controller may be secured, thereby eliminating the time delay element and securing the control cycle. That is, the phase difference in each controller is 30 degrees, and 12 phases may be controlled to perform multi-phase control, such that the unit cost and size of the passive components may be reduced.

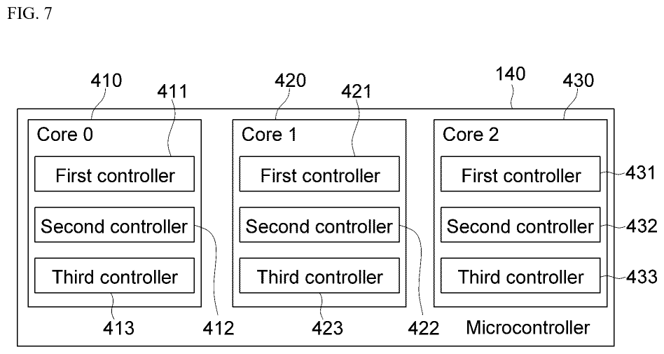

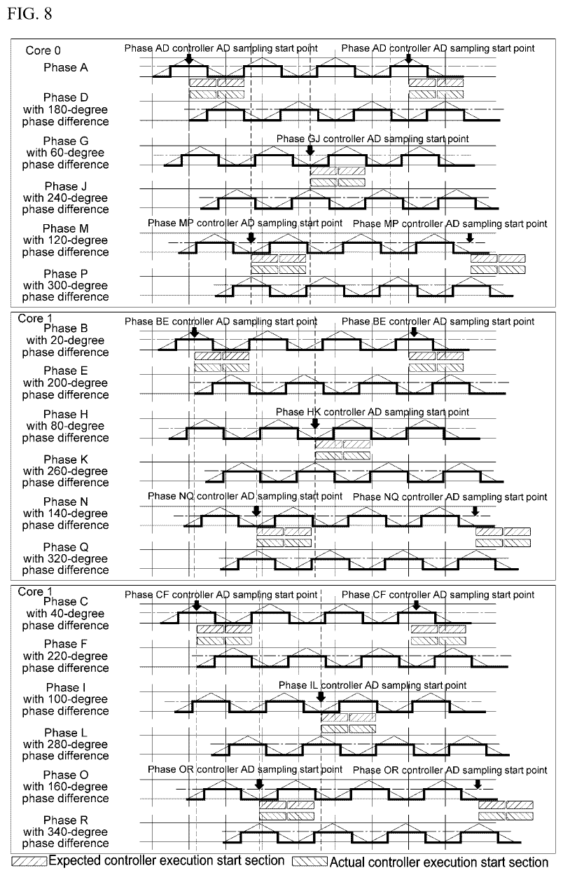

FIG. 7 is a diagram illustrating yet another example of the configuration of the controller of the microcontroller of FIG. 2, and FIG. 8 is a diagram illustrating an output signal of a multi-phase PWM control method of FIG. 7.

As illustrated in FIG. 7, the microcontroller 140 may include three cores 410, 420, 430 (core 0, core 1, core 2), and a first controller 411, 421, 431, a second controller 412, 422, 432, and a third controller 413, 423, 433 of each core 410, 420, 430 (core 0, core 1, core 2) may control two phases having a phase difference of 180 degrees. Here, each controller may output two-phase PWM signals, and accordingly, a total of 18 phases may be controlled.

More specifically, as illustrated in FIG. 8, each phase of the first core 410 (core 0) may be controlled to sequentially have a phase difference of 20 degrees with each phase of the second core 420 (core 1), and each phase of the second core 420 (core 1) may be controlled to sequentially have a phase difference of 20 degrees with each phase of the third core 430 (core 2). Here, the first controller, the second controller, and the third controller of each core may perform AD sampling and analog-to-digital conversion for the phase at a center point of a PWM duty when AD sampling and analog-to-digital conversion are completed.

For example, the first controller 411 of the first core 410 (core 0) performs AD sampling and analog-to-digital conversion for a phase A and a phase D at a center point of a PWM duty.

Then, at a point in time when the AD sampling and analog-to-digital conversion of the phase A and the phase D of the first controller 411 of the first core are completed, the third controller 413 of the first core 410 (core 0) performs AD sampling and analog-to-digital conversion of a phase M and a phase P at a center point of a PWM duty.

Then, at a point in time when the AD sampling and analog-to-digital conversion of the phase M and the phase P of the third controller 413 of the first core are completed, the second controller 412 of the first core performs AD (Analog Digital) sampling of a phase G and a phase J at a center point of a PWM duty.

In addition, the first controller 421 of the second core 410 (core 0) performs AD sampling and analog-to-digital conversion of a phase B and a phase E at a center point of a PWM duty.

Then, at a point in time when the AD sampling and analog-to-digital conversion of the phase B and the phase E of the first controller 421 of the second core 420 (core 1) are completed, the third controller 423 performs AD sampling and analog-to-digital conversion of a phase N and a phase Q at a center point of a PWM duty.

Then, at a point in time when the AD sampling and analog-to-digital conversion of the phase N and the phase Q of the third controller 423 are completed, the second controller 422 of the second core 420 (core 1) performs AD sampling and analog-to-digital conversion of a phase H and a phase K at a center point of a PWM duty.

In addition, the first controller 431 of the third core 430 (core 2) performs AD sampling and analog-to-digital conversion of a phase C and a phase F at a center point of a PWM duty. Then, at a point in time when the AD sampling and analog-to-digital conversion of the phase C and the phase F of the first controller 431 are completed, the third controller 433 performs AD sampling and analog-to-digital conversion of a phase O and a phase R.

Then, at a point in time when the AD sampling and analog-to-digital conversion of the phase O and the phase R of the third controller 433 are completed, the second controller 432 of the third core 430 (core 2) performs AD sampling and analog-to-digital conversion of a phase I and a phase L at a center point of a PWM duty.

Here, in order to secure the control execution time of each core, the control may be performed once every three PWM cycles, such that in each core, the third controller performs after the first controller is completed, and the second controller performs after the third controller is completed, repeatedly.

Accordingly, in each core of the present disclosure described above, two phases having a phase difference of 180 degrees may be assigned, and three controllers may control the PWM signal, such that the controllable time for each controller may be secured, thereby eliminating the time delay element and securing the control cycle.

That is, the phase difference in each controller may be 20 degrees, and 18 phases may be controlled to perform multi-phase control, thereby reducing the unit price and size of the passive component.

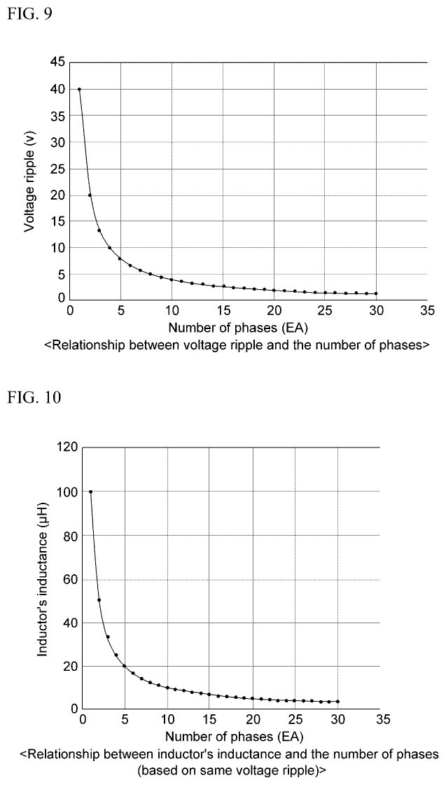

FIG. 9 is a graph illustrating the relationship of a typical voltage ripple against the

number of phases, and FIG. 10 is a graph illustrating the relationship of an inductor capacity against the number of phases based on a typical same voltage ripple.

As illustrated in FIGS. 9 and 10, as the number of phases increases, the voltage ripple decreases, and as the number of phases increases based on the same voltage ripple, the inductor capacity may be reduced. That is, as the number of phases increases, a size of the inductor may decrease, a power density may increase, the cost may decrease due to the reduction in the inductor development cost and the reduction in the overall package.

A control method for multi-phase control of a high-voltage converter according to an embodiment of the present disclosure is identical to the description of an operation of the control system for multi-phase control of the high-voltage converter of FIGS. 3 to 8 described above, and thus, description thereof will be omitted.

The above description of the present disclosure is for illustrative purposes, and those skilled in the art will understand that the present disclosure may be easily modified into other specific forms without changing the technical idea or essential features of the present disclosure. Accordingly, it should be understood that the embodiments described above are exemplary in all respects and not limiting. For example, each component described as a single type may be implemented in a distributed manner, and likewise, components described as distributed may be implemented in a combined form.

The scope of the present disclosure is indicated by the claims described below rather than the detailed description above, and all changes or modifications derived from the meaning and scope of the claims and their equivalent concepts should be interpreted as being included in the scope of the present disclosure.

### DESCRIPTION OF REFERENCE NUMERALS

110 - - - Input stage
120 - - - Output stage
130 - - - Multi-phase converter
140 - - - Microcontroller
210, 310, 410 - - - First core
320, 420 - - - Second core
330, 430 - - - Third core
211, 311, 321, 331, 411, 421, 431 - - - First controller
212, 312, 322, 332, 412, 422, 432 - - - Second controller
413, 423, 433 - - - Third controller

What is claimed is:

1. A control system for multi-phase control of a high-voltage converter, the control system comprising:
a multi-phase converter comprising inputs and outputs each connected in parallel to convert a direct current (DC) input voltage into a DC output voltage of a different level, and having different phases; and
a microcontroller outputting a control signal, which is a PWM signal, to boost or lower the DC input voltage of the multi-phase converter to the DC output voltage of a different level,
wherein the microcontroller comprises at least one core, and
the core comprises:
a first controller controlling two phases of the multi-phase converter having a phase difference of 180 degrees; and
a second controller controlling two different phases of the multi-phase converter having a phase difference of 180 degrees and having a predetermined phase difference from the two phases of the first controller.

2. The control system for multi-phase control of the high-voltage converter of claim 1,
wherein when the core of the microcontroller is a single core and the first controller and the second controller control four phases, a first phase of the first controller has a phase difference of 90 degrees from a first phase of the second controller, and a second phase of the first controller has a phase difference of 90 degrees from a second phase of the second controller.

3. The control system for multi-phase control of the high-voltage converter of claim 1,
wherein the first controller and the second controller perform AD sampling and analog-to-digital conversion for each phase at a center point of a PWM duty, and perform AD sampling and analog-to-digital conversion of the second controller at a point in time when each AD sampling and analog-to-digital conversion of the first controller is completed.

4. The control system for multi-phase control of the high-voltage converter of claim 1,
wherein when the microcontroller includes three cores, and the three cores control 12 phases, each core including a first controller and a second controller each controlling 2 phases, each phase of the first core is controlled to sequentially have a phase difference of 30 degrees from each phase of the second core, and each phase of the second core is controlled to sequentially have a phase difference of 30 degrees from each phase of the third core.

5. The control system for multi-phase control of the high-voltage converter of claim 4,
wherein the first controller and the second controller of each core control two phases having a phase difference of 180 degrees,
the first controller and the second controller of each core perform AD sampling and analog-to-digital conversion for each phase at a center point of a PWM duty, and
AD sampling and analog-to-digital conversion of the second controller are performed at a point in time when each AD sampling and analog-to-digital conversion of the first controller is completed.

6. The control system for multi-phase control of the high-voltage converter of claim 1,
wherein when the microcontroller includes three cores, and the three cores control 18 phases, each core including a first controller, a second controller and a third controller each controlling 2 phases, each phase of the first core is controlled to sequentially have a phase difference of 20 degrees from each phase of the second core, and each phase of the second core is controlled to sequentially have a phase difference of 20 degrees from each phase of the third core.

7. The control system for multi-phase control of the high-voltage converter of claim 6,
wherein the first controller, the second controller and the third controller of each core control two phases having a phase difference of 180 degrees,
the first controller, the second controller and the third controller of each core perform AD sampling and analog-to-digital conversion for each phase at a center point of a PWM duty,
AD sampling and analog-to-digital conversion of the second controller are performed at a point in time when each AD sampling and analog-to-digital conversion of the first controller is completed, and
AD sampling and analog-to-digital conversion of the third controller are performed at a point in time when each AD sampling and analog-to-digital conversion of the second controller is completed.

8. A control method for multi-phase control of a high-voltage converter, the control method comprising:
outputting, from a microcontroller to a multi-phase converter comprising inputs and outputs each connected in parallel to convert a direct current (DC) input voltage into a DC output voltage of a different level, and having different phases, a control signal to boost or lower the DC input voltage of the multi-phase converter to the DC output voltage of a different level, the control signal being a PWM signal,
wherein in a core of the microcontroller, a first controller controls two phases of the multi-phase converter having a phase difference of 180 degrees, and a second controller controls two different phases of the multi-phase converter having a phase difference of 180 degrees and having a predetermined phase difference from the two phases of the first controller.

9. The control method for multi-phase control of the high-voltage converter of claim 1,
wherein when the core of the microcontroller includes a single core and the first controller and the second controller control four phases, a first phase of the first controller has a phase difference of 90 degrees from a first phase of the second controller, and a second phase of the first controller has a phase difference of 90 degrees from a second phase of the second controller.

10. The control method for multi-phase control of the high-voltage converter of claim 1,
wherein the first controller and the second controller perform AD sampling and analog-to-digital conversion for each phase at a center point of a PWM duty, and perform AD sampling and analog-to-digital conversion of the second controller at a point in time when each AD sampling and analog-to-digital conversion of the first controller is completed.

11. The control method for multi-phase control of the high-voltage converter of claim 1,
wherein when the microcontroller includes three cores, and the three cores control 12 phases, each core including a first controller and a second controller each controlling 2 phases, each phase of the first core is controlled to sequentially have a phase difference of 30 degrees from each phase of the second core, and each phase of the second core is controlled to sequentially have a phase difference of 30 degrees from each phase of the third core.

12. The control method for multi-phase control of the high-voltage converter of claim 4,
wherein the first controller and the second controller of each core control two phases having a phase difference of 180 degrees,
the first controller and the second controller of each core perform AD sampling and analog-to-digital conversion for each phase at a center point of a PWM duty, and
AD sampling and analog-to-digital conversion of the second controller are performed at a point in time when each AD sampling and analog-to-digital conversion of the first controller is completed.

13. The control method for multi-phase control of the high-voltage converter of claim 1,
wherein when the microcontroller includes three cores, and the three cores control 18 phases, each core including a first controller, a second controller and a third controller each controlling 2 phases, each phase of the first core is controlled to sequentially have a phase difference of 20 degrees from each phase of the second core, and each phase of the second core is controlled to sequentially have a phase difference of 20 degrees from each phase of the third core.

14. The control method for multi-phase control of the high-voltage converter of claim 6,
wherein the first controller, the second controller and the third controller of each core control two phases having a phase difference of 180 degrees,
the first controller, the second controller and the third controller of each core perform AD sampling and analog-to-digital conversion for each phase at a center point of a PWM duty,
AD sampling and analog-to-digital conversion of the second controller are performed at a point in time when each AD sampling and analog-to-digital conversion of the first controller is completed, and
AD sampling and analog-to-digital conversion of the third controller are performed at a point in time when each AD sampling and analog-to-digital conversion of the second controller is completed.
